(19) United States
(12) Patent Application Publication
(10) Pub. No.: US 2009/0029152 A1
(43) Pub. Date: Jan. 29, 2009

(54) Wafer Bonding Using Nanoparticle Material

(75) Inventors: Changhan Yun, Cambridge, MA (US); Dewali Ray, Boise, ID (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/828,075

(22) Filed: Jul. 25, 2007

(51) Int. Cl. B32B 5/16; B32B 37/14

(52) U.S. Cl. 428/328; 156/60

(57) ABSTRACT

A method of forming a MEMS device includes providing a first wafer having a MEMS structure in a first area and a second wafer having a second area, applying a metal nanoparticle material between the first wafer and the second wafer, and bonding a portion of the first wafer to a portion of the second wafer with the metal nanoparticle material so as to form a sealed area in the first area and the second area.

### FIELD OF THE INVENTION

The invention generally relates to wafer bonding and, more particularly, the invention relates to wafer bonding using a nanoparticle material.

### BACKGROUND OF THE INVENTION

Wafers may include a variety of structures and/or devices that need to be bonded together. For example, in microelectromechanical systems (MEMS) devices, certain micromachined structures may be formed in a wafer using micromachining processes. These MEMS structures are designed to move relative to a substrate and other micromachined structures in response to forces applied. One type of MEMS accelerometer, for example, employs a movable mass constructed with fingers adjacent and parallel to fingers of one or more fixed, non-moving structures, with all of these structures suspended in a plane above the substrate. Because of the mechanical structures involved and the required device sensitivity, MEMS devices are commonly covered or bonded with a cap structure to protect them from hazards that may impact the functioning of the device, e.g., from air, particles, moisture.

Wafer bonding processes, however, may involve high temperatures and/or may be performed in high vacuum conditions, which may adversely affect the structures or circuitry formed on or within the wafers. In addition, for some applications, a conductive wafer bonding material may be desired, e.g., for interconnection through the wafer(s) or the cap sealing of MEMS packages in some instances. However, metal to metal thermo-compression bonding techniques typically require high pressure, high temperature, long bonding times and vacuum deposition techniques, which may increase the cost and time to process the device.

### SUMMARY OF THE INVENTION

In accordance with one embodiment of the invention, a method of forming a MEMS device includes providing a first wafer having a MEMS structure in a first area and a second wafer having a second area, applying a metal nanoparticle material between the first wafer and the second wafer, and bonding a portion of the first wafer to a portion of the second wafer with the metal nanoparticle material so as to form a sealed area in the first area and the second area.

In accordance with related embodiments, bonding may include applying pressure to and heating the first wafer, the second wafer and the metal nanoparticle material. Applying may include using a stamp printing process, using an inkjet printing process, using a screen printing process and/or using a spin coating process. The sealed area may be an hermetically sealed area. The second wafer may include a cap that protects the MEMS structure. The second wafer may include an integrated circuit formed within the second wafer. The metal nanoparticle material may have an average particle diameter of less than about 1 μm or less than about 20 nm. The metal nanoparticle material may include nanotubes relatively cylindrical in shape. The metal nanoparticle material may include silver, gold, nickel, tungsten, aluminum, copper and/or platinum.

In accordance with another embodiment of the invention, a method of bonding wafer devices includes providing a first wafer having a first region protruding from a surface of the first wafer and a second wafer having a second region protruding from a surface of the second wafer, applying a metal nanoparticle material to the first region, placing the second region in contact with the metal nanoparticle material, and bonding the first region to the second region with the metal nanoparticle material so as to form a sealed area between the first wafer and the second wafer.

In accordance with related embodiments, the second wafer may include a MEMS structure and the first wafer may include a cap that protects the MEMS structure. Bonding may include applying pressure to and heating the first wafer, the second wafer and the metal nanoparticle material. Applying may include using a stamp printing process, using an inkjet printing process, using a screen printing process and/or using a spin coating process. The sealed area may be an hermetically sealed area. The first wafer or the second wafer may include an integrated circuit formed within the first or the second wafers. The metal nanoparticle material may have an average particle diameter of less than about 20 nm, or less than about 10 nm.

In accordance with another embodiment of the invention, a MEMS device includes a first wafer having a MEMS structure in a first area, a second wafer having a second area, and a metal nanoparticle material bonding a portion of the first wafer to a portion of the second wafer so as to form a sealed area in the first area and the second area.

In accordance with related embodiments, the second wafer may include a cap that protects the MEMS structure.

### BRIEF DESCRIPTION OF THE DRAWINGS

The foregoing advantages of the invention will be appreciated more fully from the following further description thereof with reference to the accompanying drawings wherein:

FIG. 1 schematically shows a cross sectional view of one wafer with a MEMS structure according to illustrative embodiments of the present invention;

FIG. 2 schematically shows a cross sectional view of another wafer with of a cap structure for a MEMS device according to illustrative embodiments of the present invention;

FIG. 3 shows a process of forming a MEMS device according to illustrative embodiments of the present invention;

FIGS. 4A-4D show one exemplary process of applying a nanoparticle material between two wafers according to illustrative embodiments of the present invention; and

FIG. 5 shows a process of bonding wafer devices according to illustrative embodiments of the present invention.

### DESCRIPTION OF ILLUSTRATIVE EMBODIMENTS

Embodiments of the present invention include a wafer bonding process using a nanoparticle material that bonds two or more wafers together to form a covered or sealed area. The bonding process provides a low temperature, low pressure method for applying the nanoparticle material to the wafers and subsequently bonding the wafers together. Embodiments include applying the nanoparticle material to one or both wafers using a variety of deposition techniques, such as a stamp printing process, an inkjet printing process, a screen printing process, a spin coating process and/or a vacuum deposition process. Details of illustrative embodiments are discussed below.

Although the following discussion describes various relevant steps of forming a MEMS device or bonding wafer devices, it does not describe all the required steps. Other processing steps may also be performed before, during, and/or after the discussed steps. Such steps, if performed, have been omitted for simplicity. The order of the processing steps may also be varied and/or combined. Accordingly, some steps are not described and shown.

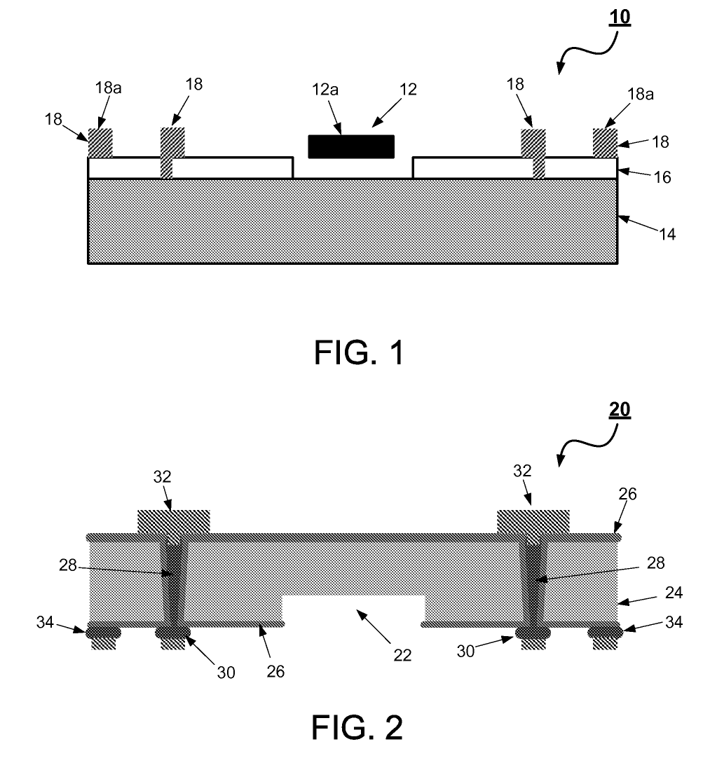

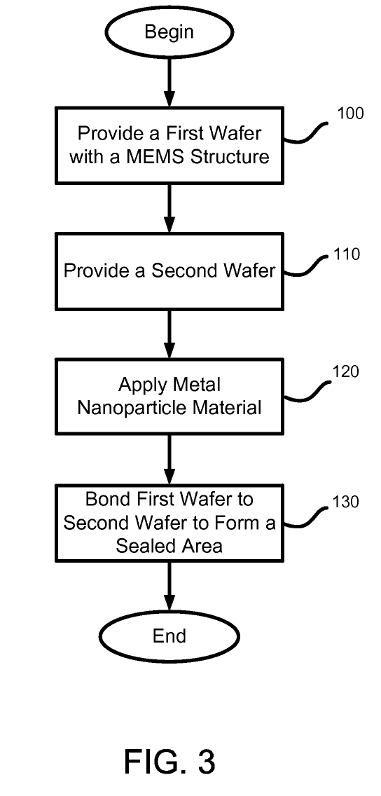

Wafers having various structures and/or circuitry formed therein may be bonded together according to illustrative embodiments of the present invention. For example, FIG. 1 schematically shows a cross sectional view of one wafer 10 having a MEMS structure 12 formed therein and FIG. 2 schematically shows a cross sectional view of another wafer 20 having a cap structure 22 for a MEMS device formed therein.

Referring to FIGS. 1-3, a process of forming a MEMS device begins at step 100, which provides a first wafer 10 having a MEMS structure 12. As shown in FIG. 1, the MEMS structure 12 is suspended in a plane above a substrate 14. The substrate 14 may be formed from a single crystal silicon wafer or a silicon-on-insulator (“SOI”) wafer. The substrate 14 may have one or more layers 16 formed on its surface. The layers 16 may include one or more layers of materials typically used in the manufacture of a MEMS device, such as an oxide layer, a polysilicon layer, a nitride layer, etc., as is well known to those skilled in the art. The various layers 16 may be masked off or patterned using processes well known to those skilled in the art, e.g., using photolithography and etching techniques.

The substrate 14 may also include regions or posts 18 raised up or protruding from the surface of the substrate 14. For example, the regions 18 may be formed from a conducting material (e.g., polysilicon or metal) and provide an electrical contact and interface for the MEMS device. The regions 18 may be used to connect the MEMS device to circuitry formed in and/or on another region of the substrate 14 or circuitry formed in and/or on another wafer or die. The top surface 18a of the regions 18 may be higher or lower than the top surface 12a of the MEMS structure 12.

In step 110, a second wafer is provided. The second wafer may be any wafer, e.g., having various structures and/or circuitry formed therein. One exemplary wafer 20 is shown in FIG. 2, which has a cap structure 22 for a MEMS device formed therein. As shown in FIG. 2, the wafer 20 may include a substrate 24 having one or more layers formed on one or both surfaces. For example, an oxide layer 26 may be formed on one or both surfaces of the substrate 24 and conductive paths 28 may be formed through the substrate 24. The conductive paths 28 may provide an interconnection through the wafer 20 via a conductive area 30 at its one end and a conductive area 32 at its other end. Also, other contact areas 34 may be formed on the substrate 24 or its layers, as is well known to those skilled in the art. As shown in FIG. 2, the conductive areas 30 and contact areas 34 may be raised up or protruding from one surface of the substrate 24 and may be formed from a conducting material, e.g., polysilicon or metal. A region 22 may be formed in the substrate 24 that is recessed from one surface of the substrate 24. The region 22 may form a cap or protective structure when placed over a MEMS structure or device.

In step 120, a metal nanoparticle material may be applied between the first wafer 10 and the second wafer 20. The metal nanoparticle material may be applied to either or both wafers 10, 20 using a variety of deposition techniques, such as a stamp printing process, an inkjet printing process, a screen printing process, or a spin coating process, as is well known to those skilled in the art. Vacuum deposition techniques, such as chemical vapor deposition (CVD), may also be used to apply the nanoparticle material.

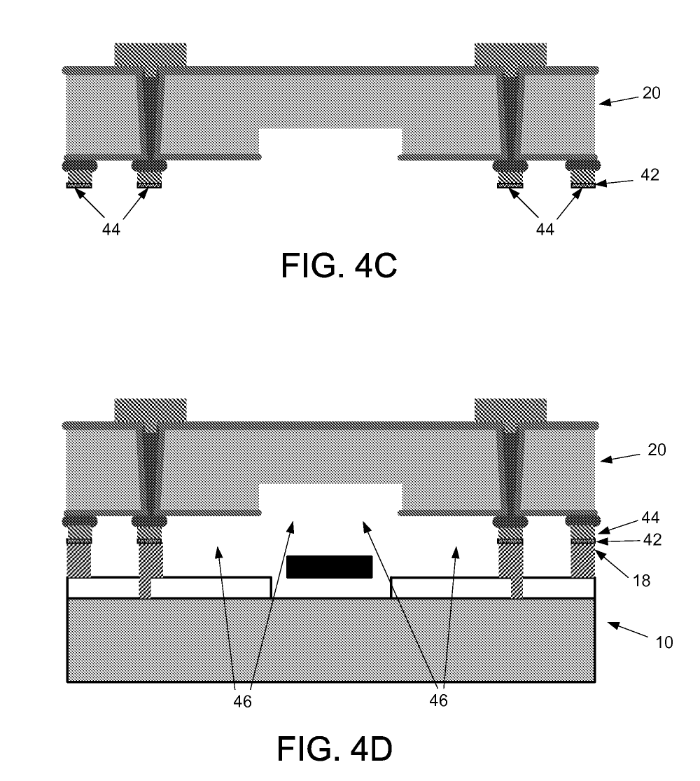

For example, FIGS. 4A through 4D show an exemplary process of applying a nanoparticle material between two wafers according to illustrative embodiments of the present invention. In the stamp printing process shown, a blanket 40 may be printed with a nanoparticle material 42 and may be aligned with one of the wafers, as shown in FIG. 4A. For example, the nanoparticle material 42 may be printed on the blanket 40 with any desired pattern and any desired deposition technique, e.g., by a screen printing process, as is well known to those skilled in the art. As shown in FIG. 4B, the wafer 20 and blanket 40 may be brought together so that areas 44 that protrude from the surface of the wafer 20 (e.g., conductive areas 30 and contact areas 34) contact the nanoparticle material 42. In doing so, some or all of the nanoparticle material 42 that was contacted on the blanket 40 may remain on the protruding areas 44, as shown in FIG. 4C. Optionally, the wafer 20 may be slightly heated in order for the nanoparticle material 42 to partially solidify or dry onto the wafer 20 or the nanoparticle material 42 may be allowed to air dry. For example, heating a wafer at about 50° C. for about 5 minutes may be sufficient if a metal nanoparticle material is used in the form of a paste or slurry having silver nanoparticles suspended therein as discussed in more detail below. As shown in FIG. 4D, the two wafers 10, 20 may be brought together such that the nanoparticle material 42 is placed between the protruding areas 44 on the one wafer 20 and the protruding regions 18 on the other wafer 10.

As mentioned, the process of applying a nanoparticle material 42 as shown and discussed in FIGS. 4A through 4D is exemplary. Thus, embodiments may vary from the process and structures shown and discussed above. For example, the nanoparticle material 42 may be applied to the first wafer 10 by the blanket 40 or may be applied to both wafers 10, 20 before placing the two wafers 10, 20 together. In addition, the nanoparticle material 42 may be applied using other processes than the stamp printing process shown and described above. For example, an inkjet printing process or a spin coating process may be used to print the nanoparticle material 42 onto the blanket 40 or may be used to apply the nanoparticle material 42 directly onto either or both wafers 10, 20. Similarly, the nanoparticle material 42 may be applied directly onto either or both wafers 10, 20 using the screen printing process. The nanoparticle material 42 may also be formed directly onto either or both wafers 10, 20 using vacuum deposition techniques, such as CVD, and may be patterned using processes well known to those skilled in the art. Other deposition processes may also be used, as are well known to those skilled in the art. In addition, depending on the application, the nanoparticle material 42 may include conductive, metal nanoparticles and/or may include non-conductive nanoparticles.

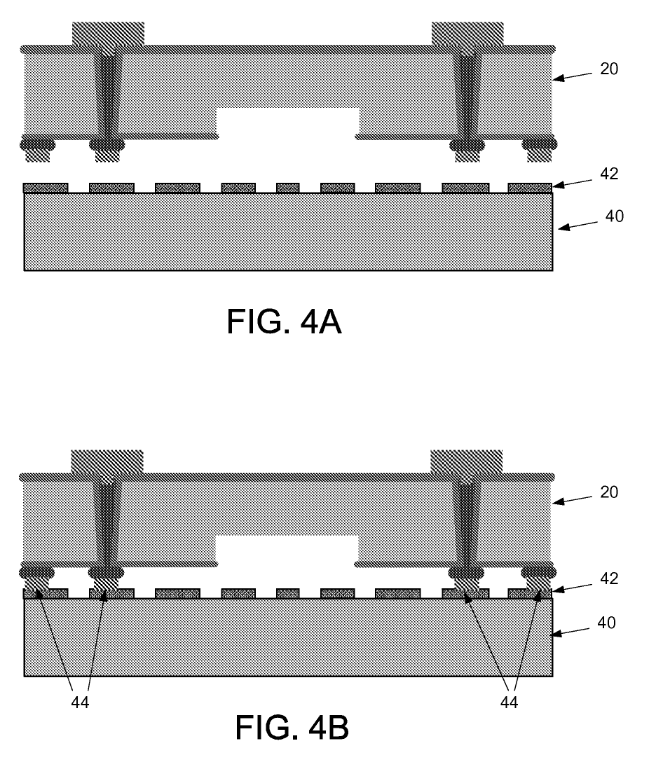

Referring again to FIG. 3, the first wafer 10 may be bonded to the second wafer 20 using the nanoparticle material 42 to form a covered or sealed area in step 130. For example, referring to FIG. 4D, the covered or sealed area 46 may include the area around where the MEMS structure 12 is formed on the first wafer 10 and the area around where the cap structure 22 is formed on the second wafer 20, as well as other areas. The sealed area 46 may or may not be an hermetically sealed area.

The bonding process may include the application of heat and/or pressure to the first wafer 10, the second wafer 20 and the nanoparticle material 42 depending on the nanoparticle material 42 chosen. Nanoparticle materials often provide unusual or unique properties due to the large surface to volume ratio of its nanoparticles. As such, electrical, thermal, mechanical and/or chemical properties of materials are often changed or enhanced when the average particle size in a composition is reduced to the nanoscale. For example, the melting point of a given material may be lowered or suppressed as the particle radius approaches the sub-20 nm range. Thus, a low pressure, low temperature bonding process may be provided depending on the appropriate selection of the nanoparticle material, such as composition, average nanoparticle size, nanoparticle shape etc.

Accordingly, the nanoparticle material 42 may include a powder of nanoparticles suspended in a solution to form a paste. The viscosity of the paste may vary depending on the deposition technique used to apply the nanoparticle material 42. When in the form of a paste, the composition of the nanoparticle material 42 may include about 80 wt % of nanoparticles, about 10-13 wt % water and about 7-10 wt % of a surfactant. The nanoparticle material 42 may be deposited and formed on the wafer under the proper processing parameters. For example, a carbon-based organic material such as commonly used in a patterning process, (e.g., photoresist) may be deposited (e.g., using CVD) onto the wafer. The material may be patterned as well known to those skilled in the art. Under the proper processing techniques (e.g., gas, temperature and pressure), the nanoparticle material may be formed or grown from the deposited material, e.g., in the shape of nanotubes, such as carbon nanotubes.

The chemical composition of the nanoparticles may include metal nanoparticles, e.g., silver, gold, nickel, tungsten, aluminum, copper, platinum and/or alloys thereof, although other metal or non-metal compositions may be used for the nanoparticles depending on the application. The nanoparticles may be relatively spherical or rounded in shape, or may be relatively cylindrical in shape, although other particle shapes may be used. Preferably, the nanoparticles may have an average particle size (diameter) of less than 1 μm, more preferably an average particle size of less than 20 nm or less than 10 nm. As used herein, the particle size or diameter may be the diameter of a relatively cylindrical shape or a relatively rounded, spherical shape. An example of a suitable silver nanoparticle material is commercially available from PChem Associates, Inc. of Bensalem, Pa.

The chemical composition of the nanoparticles may be selected depending on the chemical composition of the areas to be bonded on the two wafers 10, 20. For example, if a conductive bond is desired to connect conductive areas (e.g., polysilicon, titanium tungsten (TiW), platinum, aluminum) on the wafers 10, 20, then silver or another metal nanoparticle material may be used. Also, the chemical composition of the nanoparticles may be selected so that the bonding process parameters used may not damage any structures and/or circuitry on the wafers 10, 20. For example, if a silver nanoparticle composition is used having an average particle size of less than 20 nm, the wafers 10, 20 may be bonded using a temperature of about 250-300° C. for about 15 minutes, although longer bonding times and higher bonding temperatures may be used. The wafers 10, 20 and the nanoparticle material 42 may be heated by placing one or both wafers in contact with a heated surface or placing the wafers 10, 20 and the nanoparticle material 42 in an oven. In addition, a low pressure may be used on the wafers 10, 20 and nanoparticle material 42 during the bonding process. For example, a weight may be placed on one of the wafers 10, 20 (e.g., a 10 lb weight on a 6 inch wafer may be used) or a force may be applied to both the wafers 10, 20.

To complete the process of forming the MEMS device discussed in FIG. 3, other processing steps may be used. For example, if done in a batch process, the wafer(s) may be diced to form a plurality of individual dies. As used herein, the terms “wafer” and “die” may be used interchangeably, although a wafer may form a plurality of individual dies. Some embodiments may implement post-processing methods for integrating the MEMS device with circuitry on the same die or another die. In addition, other processing steps may be performed on the cap wafer to integrate it with packages or other components and/or devices.

As mentioned, the wafers 10, 20 shown and discussed in FIGS. 1 and 2 and the process described in FIG. 3 are exemplary. Thus, two or more wafers having other structures and/or circuitry may be bonded together according to embodiments of the present invention. For example, a wafer having an integrated circuit formed within it may be bonded to the first wafer 10 having a MEMS structure 12. Accordingly, embodiments may vary from the process and structures shown and discussed above.

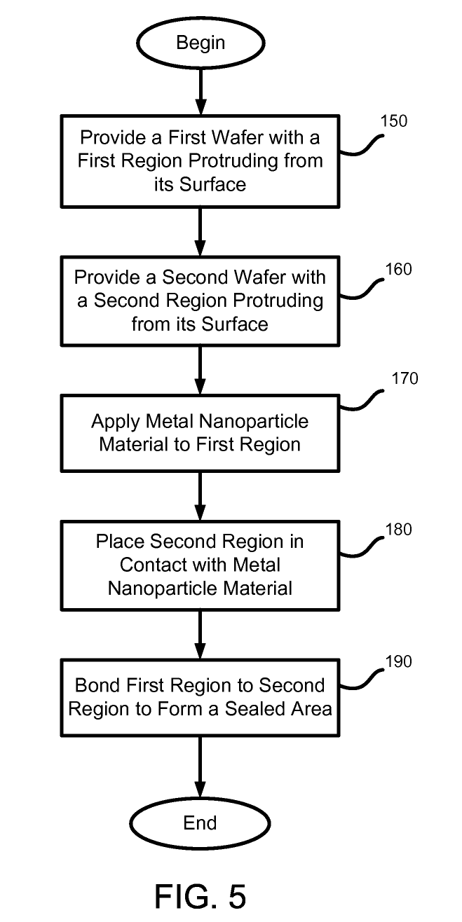

FIG. 5 shows a process of bonding wafer devices according to illustrative embodiments of the present invention. The process begins by providing a first wafer with a first region protruding from its surface (step 150) and a second wafer with a second region protruding from its surface (step 160). The first and second wafers may be wafers 10, 20 and/or other wafers having other structures and/or circuitry formed on and/or within the wafers. For example, the first and/or second wafers may be wafers with circuitry formed within the wafer and assembled in a flip chip configuration rather than a wire bonding assembly configuration. In this situation, the surface of the wafers may be the circuitry or other electronic components and the regions protruding from the surface may be conductive bumps that attach the wafer to a circuit board or other substrate.

In step 170, a metal nanoparticle material may be applied to the first region on the first wafer. The nanoparticle material may be applied as discussed above with respect to FIG. 3. In step 180, the second region on the second wafer may be placed in contact with the metal nanoparticle material applied to the first region. In step 190, the first region may be bond to the second region to form a sealed area. The bonding process may be similar to that discussed above with respect to FIG. 3. The sealed area may or may not include an hermetically sealed area.

Although the above discussion discloses bonding two wafers, a plurality of wafers may be bonded to one another by repeating steps 150-step 190 of the wafer bonding process. For example, a third wafer may be provided with a region protruding from its surface and the nanoparticle material may be applied to the third wafer and/or the wafer that includes the combined first and second wafer bonded together. The third wafer and the first/second wafer may then be bonded together to form another sealed area between the third wafer and the first or second wafer which ever is adjacent to the third wafer. Also, the nanoparticle material may include non-conductive particles instead of, or in addition to, the conductive, metal nanoparticles.

Although the above discussion discloses various exemplary embodiments of the invention, it should be apparent that those skilled in the art can make various modifications that will achieve some of the advantages of the invention without departing from the true scope of the invention.

What is claimed is:

1. A method of forming a MEMS device, the method comprising:
providing a first wafer having a MEMS structure in a first area and a second wafer having a second area;
applying a metal nanoparticle material between the first wafer and the second wafer; and
bonding a portion of the first wafer to a portion of the second wafer with the metal nanoparticle material so as to form a sealed area in the first area and the second area.

2. The method of claim 1, wherein bonding includes applying pressure to and heating the first wafer, the second wafer and the metal nanoparticle material.

3. The method of claim 1, wherein applying includes using a stamp printing process, using an inkjet printing process, using a screen printing process, using a spin coating process, using a vacuum deposition process, or a combination thereof.

4. The method of claim 1, wherein the sealed area is an hermetically sealed area.

5. The method of claim 1, wherein the second wafer includes a cap that protects the MEMS structure.

6. The method of claim 1, wherein the second wafer includes an integrated circuit formed within the second wafer.

7. The method of claim 1, wherein the metal nanoparticle material has an average particle diameter of less than about 1 μm.

8. The method of claim 7, wherein the metal nanoparticle material has an average particle diameter of less than about 20 nm.

9. The method of claim 1, wherein the metal nanoparticle material includes nanotubes relatively cylindrical in shape.

10. The method of claim 1, wherein the metal nanoparticle material includes silver, gold, nickel, tungsten, aluminum, copper, platinum, or a combination thereof.

11. A method of bonding wafer devices, the method comprising:
providing a first wafer having a first region protruding from a surface of the first wafer and a second wafer having a second region protruding from a surface of the second wafer;
applying a metal nanoparticle material to the first region;
placing the second region in contact with the metal nanoparticle material; and
bonding the first region to the second region with the metal nanoparticle material so as to form a sealed area between the first wafer and the second wafer.

12. The method of claim 11, wherein the second wafer includes a MEMS structure and the first wafer includes a cap that protects the MEMS structure.

13. The method of claim 11, wherein bonding includes applying pressure to and heating the first wafer, the second wafer and the metal nanoparticle material.

14. The method of claim 11, wherein applying includes using a stamp printing process, using an inkjet printing process, using a screen printing process, using a spin coating process, using a vacuum deposition process, or a combination thereof.

15. The method of claim 11, wherein the sealed area is an hermetically sealed area.

16. The method of claim 11, wherein the first wafer or the second wafer includes an integrated circuit formed within the first or the second wafers.

17. The method of claim 11, wherein the metal nanoparticle material has an average particle diameter of less than about 20 nm.

18. The method of claim 11, wherein the metal nanoparticle material has an average particle diameter of less than about 10 nm.

19. A MEMS device comprising:
a first wafer having a MEMS structure in a first area;
a second wafer having a second area; and
a metal nanoparticle material bonding a portion of the first wafer to a portion of the second wafer so as to form a sealed area in the first area and the second area.

20. The device of claim 19, wherein the second wafer includes a cap that protects the MEMS structure.
